(19) United States
(12) Patent Application Publication
(10) Pub. No.: US 2024/0064256 A1
(43) Pub. Date: Feb. 22, 2024

(54) INSTALLATION PROCESSING DEVICE, INSTALLATION PROCESSING METHOD, AND IMAGE FORMING DEVICE

(71) Applicant: Toshiba Tec Kabushiki Kaisha, Tokyo (JP)

(72) Inventor: Shigeo UCHIDA, Mishima (JP)

(73) Assignee: Toshiba Tec Kabushiki Kaisha, Tokyo (JP)

(21) Appl. No.: 18/358,673

(22) Filed: Jul. 25, 2023

(30) Foreign Application Priority Data
Aug. 22, 2022 (JP) 2022-132058

(51) Int. Cl. H04N 1/32; H04N 1/00

(52) U.S. Cl. CPC H04N 1/32128; H04N 1/00129; H04N 1/00411; H04N 1/00503; H04N 1/00941; H04N 1/32096

(57) ABSTRACT

Provided is s technique capable of easily changing display information of an application for each destination is. An installation processing device installs an application in a device in which a destination indicating a country or a region is set. An application package of the application includes the application and replacement display information that includes second display information associated with first display information included in the application and in which the destination is set. The installation processing device includes a replacement processing unit configured to replace the first display information corresponding to the second display information by the second display information included in the replacement display information in which the same destination as the destination set in the device is set.

### CROSS-REFERENCE TO RELATED APPLICATION

This application is based upon and claims the benefit of priority from Japanese Patent Application No. 2022-132058, filed on Aug. 22, 2022, the entire contents of which are incorporated herein by reference.

### FIELD

Embodiments described herein relate generally to a technique for installing an application.

### BACKGROUND

In a device to be used in various countries or regions, for optimization, operation processing of the device may be adjusted for each destination. As the adjustment of this type, information displayed by an application operating on the device may be changed for each destination.

### DESCRIPTION OF THE DRAWINGS

FIG. 1 is a schematic diagram illustrating a schematic configuration of an image forming device according to at least one embodiment;

FIG. 2 is a block diagram illustrating a main circuit configuration;

FIG. 3 is a block diagram illustrating a functional configuration of an installation processing device;

FIG. 4 is a flowchart illustrating an operation of the installation processing device;

FIG. 5 is a schematic diagram illustrating an application package;

FIG. 6 is a schematic diagram illustrating replacement display information;

FIG. 7 is a schematic diagram illustrating decoded application data;

FIG. 8 is a schematic diagram illustrating an application selection screen in which display information is not replaced;

FIG. 9 is a schematic diagram illustrating an application selection screen in which the display information is replaced;

FIG. 10 is a schematic diagram illustrating a EULA display screen in which the display information is not replaced; and

FIG. 11 is a schematic diagram illustrating a EULA display screen in which the display information is replaced.

### DETAILED DESCRIPTION

In general, according to at least one embodiment, a technique capable of easily changing display information of an application for each destination is provided.

In at least one embodiment, an installation processing device (installation processor) installs an application in a device in which a destination indicating a country or a region is set. An application package of the application includes the application and replacement display information that includes second display information associated with first display information included in the application and in which the destination is set. The installation processing device includes a replacement processing unit (replacement processor) configured to replace the first display information corresponding to the second display information by the second display information included in the replacement display information in which the same destination as the destination set in the device is set.

Hereinafter, embodiments will be described with reference to the drawings. In the drawings, the same components are denoted by the same reference numerals.

(Hardware Configuration of Image Forming Device)

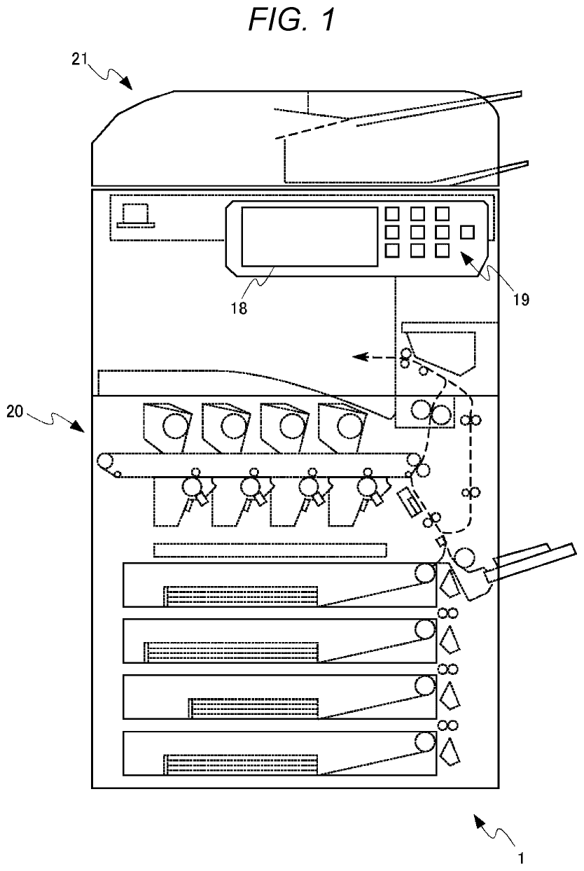

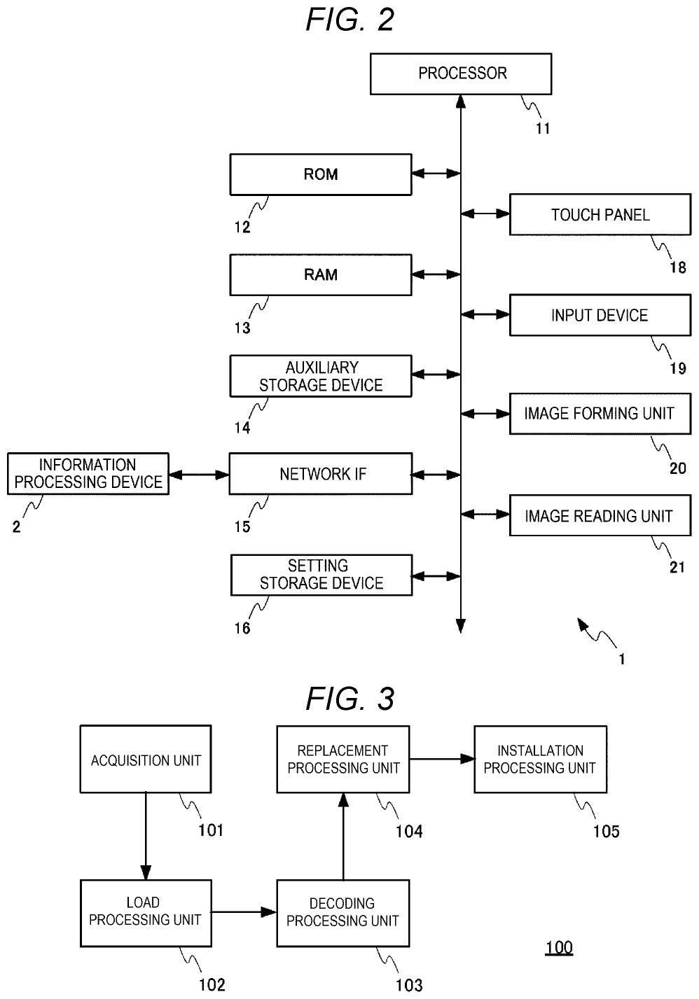

FIGS. 1 and 2 are schematic diagrams illustrating a schematic configuration and a main part circuit configuration of an image forming device according to the embodiment.

An image forming device 1 according to the embodiment is a device in which an application is installed. As illustrated in FIG. 1, the image forming device 1 includes, as hardware, a touch panel 18, an input device 19, an image forming unit 20, and an image reading unit 21, and is a multifunction peripheral (MFP) that provides a user with a printing function, a scanning function, a copying function, a facsimile function, and the like.

The image forming unit 20 is a printer that forms an image on a sheet using toner, ink, and the like, and is used to provide the user with the printing function, the copying function, and the facsimile function. The image reading unit 21 is a scanner that reads an image from a document on which the image is formed, and is used for providing the user with the scanning function, the copying function, and the facsimile function.

The touch panel 18 includes a display and a touch pad, and displays on the display a graphical user interface (GUI) for the user to use the image forming device 1, and receives an operation on the GUI by the touch pad. The input device 19 includes a plurality of physical buttons, and is used for operations related to the above-described various functions provided for the user by the image forming device 1.

As illustrated in FIG. 2, the image forming device 1 further includes, as hardware, a processor 11, a read only memory (ROM) 12, a random access memory (RAM) 13, an auxiliary storage device 14, a network interface (IF) 15, and a setting storage device 16.

The ROM 12 is a storage medium storing firmware which is basic software for operating the image forming device 1. The processor 11 is an arithmetic unit that controls the image forming unit 20 and the image reading unit 21, and executes various functions operating on the firmware of the image forming device 1 and firmware to be described later in cooperation with the RAM 13 which is a main storage device. The auxiliary storage device 14 is a device that stores various types of data used for processing executed by the firmware and various functions, and is a nonvolatile storage device such as a hard disk drive (HDD) or a flash memory. The network IF 15 is an interface for connection to a network such as the Internet. An information processing device 2 including at least a display and an input device, such as a personal computer (PC) or a tablet PC, is communicably connected to the image forming device 1 via a network such as the network IF 15.

The setting storage device 16 is a storage device that stores destination information set in the image forming device 1 prior to shipment, and is, for example, a non-volatile random access memory (NVRAM), an electric erasable programmable read-only memory (EEPROM) (registered trademark), or a static RAM (SRAM) using a battery as a power source.

The destination information indicates a country or a region in which the image forming device 1 is sold or disposed. The image forming device 1 controls the image forming unit 20 and the image reading unit 21 according to the country or the region indicated by the destination information.

Specifically, the image forming device 1 performs control suitable for a current value and a voltage value of the power source in the country or the region indicated by the destination information. Accordingly, the image forming device 1 can perform operations according to different power sources depending on countries or regions. In addition, the image forming device 1 selects, based on the destination information, a default setting of printing performed by the image forming unit 20, and determines a size of a sheet used for the printing performed by the image forming unit 20. For example, the image forming device 1 sets a letter size as a default sheet size when the destination information is set to United States, and sets an A4 size as the default sheet size when the destination information is set to Japan. When countries or regions indicated by destination information set in advance in a cartridge storing toner and ink and destination information set in advance in the image forming device 1 do not match, the image forming device 1 displays on the touch panel 18 a message for calling the user's attention. Accordingly, the user can be caused to use toner and ink optimized in a country or a region.

(Functional Configuration of Installation Processing Device)

A functional configuration of an installation processing device will be described. FIG. 3 is a block diagram illustrating the functional configuration of the installation processing device according to at least one embodiment.

The processor 11 and the RAM 13 function as an installation processing device 100 by executing an application operating on the firmware or an installation processing program which is one function included in the firmware. The installation processing device 100 includes, as functions, an acquisition unit 101, a load processing unit 102, a decoding processing unit 103, a replacement processing unit 104, and an installation processing unit 105, and installs the application operating on the firmware.

The application operating on the firmware are broadly classified into a standard application and an additional application. The standard application is an application installed in advance in the image forming device 1, and is stored in the ROM 12 or the auxiliary storage device 14. The additional application is an application that is freely installed in the image forming device 1 by the user. An application package storing the additional application is stored in an external storage device connected to the image forming device 1 or stored in a server device capable of communicating with the image forming device 1 via a network.

The installation processing device 100 installs the additional application on the image forming device 1 based on the destination information stored in the setting storage device 16. In at least one embodiment, the installation refers to storing various types of data included in the application package in an appropriate directory of the auxiliary storage device 14 such that the application can be executed on the firmware. In addition, the installation processing device 100 replaces display information during the installation of the additional application.

In at least one embodiment, the display information is a character string or an image generated by the processor 11 executing the application. The display information is information displayed on the touch panel 18 and is a character string or an image included in the application. In addition, the display information may be displayed on a display so as to be operable by the input device in the information processing device 2 communicably connected via the network IF 15. More specifically, the display information refers to information displayed when the application is executed, a character string indicating a name of the application, or a GUI component indicating the application. In addition, the GUI component of this type is an image displayed on an application selection screen that selectably displays an application as an execution target. Examples of the GUI component include application icons which are images representing applications. It is preferable that the GUI displayed on the touch panel 18 is optimized depending on a country or a region such that the user can easily use the GUI.

(Operation of Installation Processing Device)

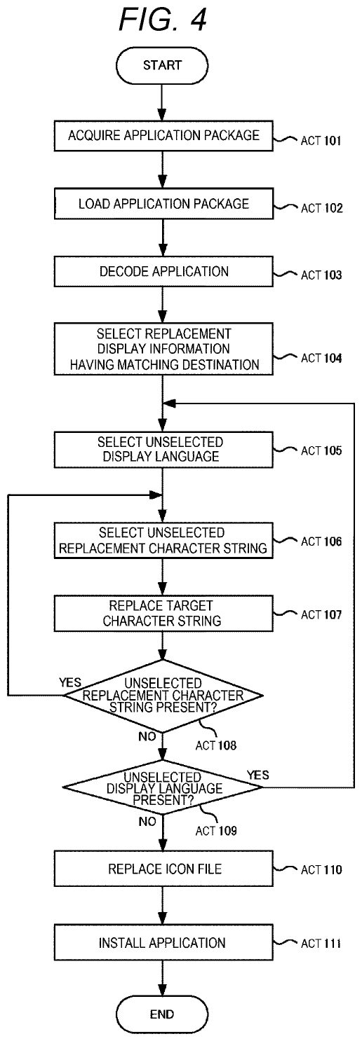

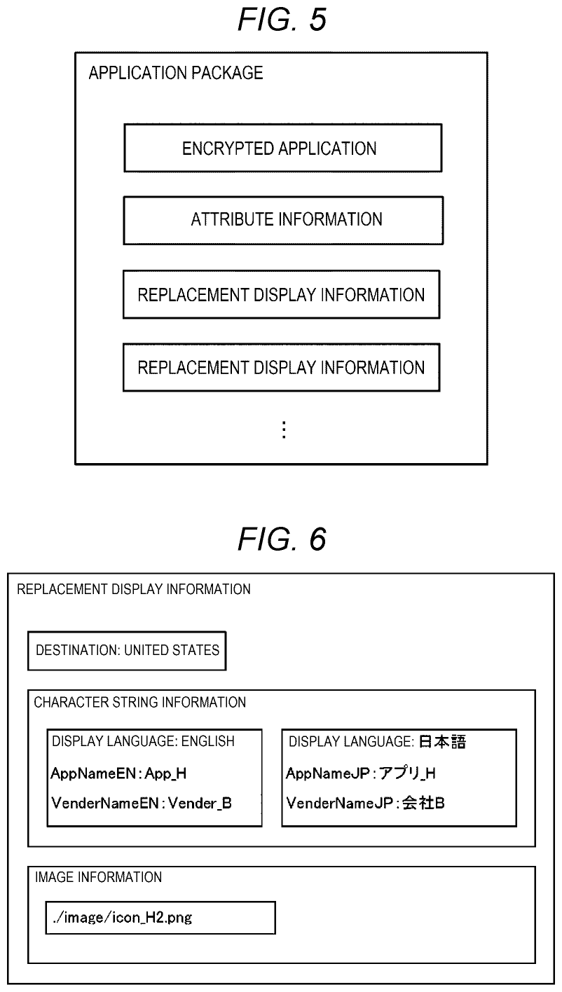

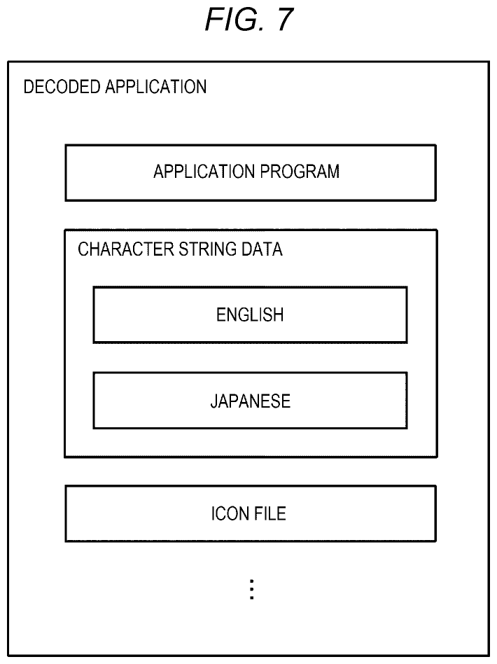

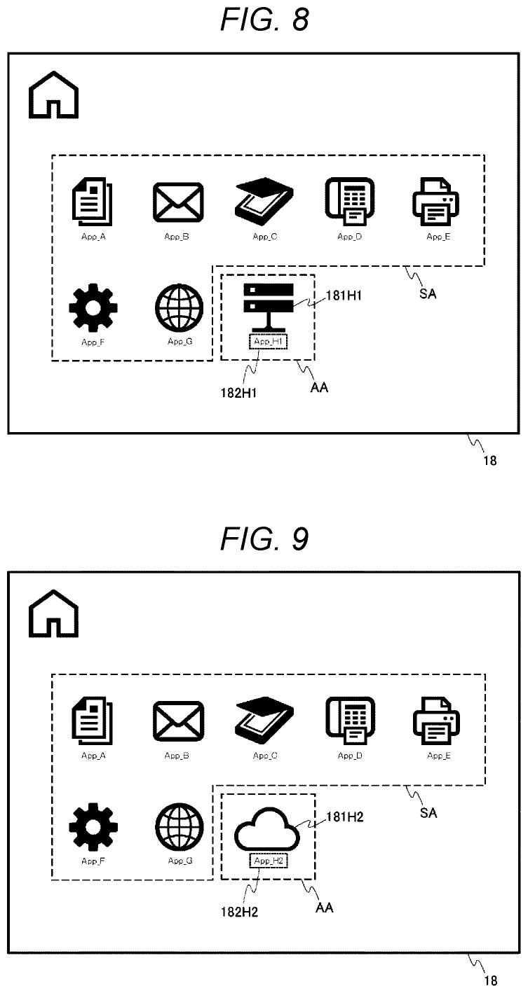

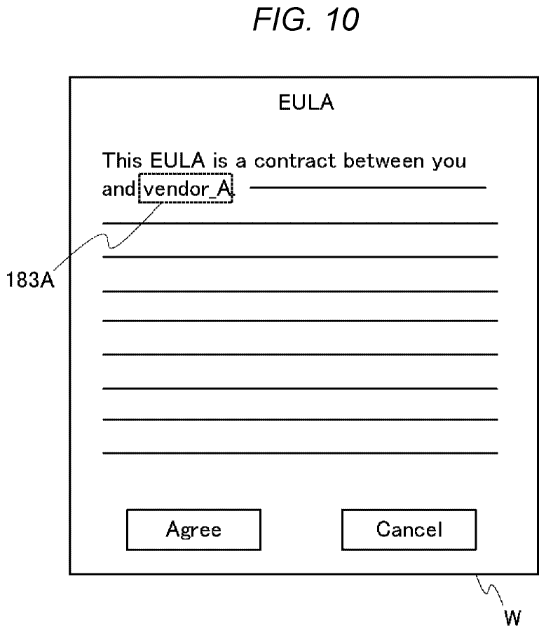

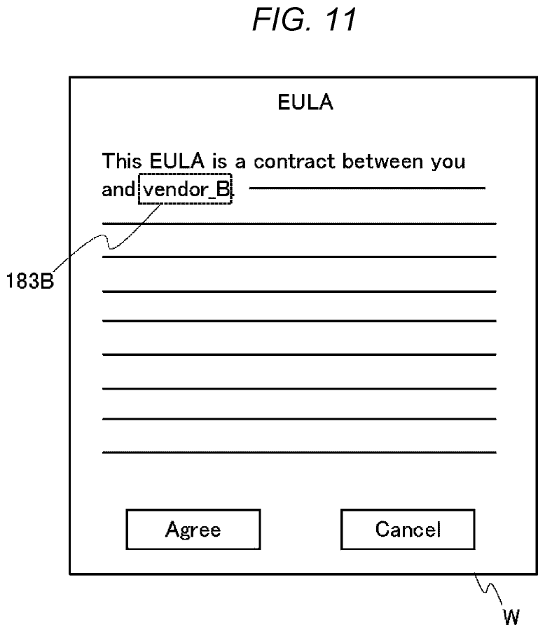

An operation of the installation processing device will be described. FIG. 4 is a flowchart illustrating the operation of the installation processing device according to at least one embodiment. FIG. 5 is a schematic diagram illustrating the application package. FIG. 6 is a schematic diagram illustrating replacement display information. FIG. 7 is a schematic diagram illustrating decoded application data. FIGS. 8 and 9 are schematic diagrams respectively illustrating an application selection screen in which the display information is not replaced and an application selection screen in which the display information is replaced. FIGS. 10 and 11 are schematic diagrams respectively illustrating a EULA display screen in which the display information is not replaced and a EULA display screen in which the display information is replaced.

In the operation illustrated in FIG. 4, it is assumed that an installation instruction of the additional application is already made by the user or an arrangement worker of the image forming device 1. In the following description, the destination information indicates a country in which the image forming device 1 is sold, and an application name, an application icon, and a character string included in the end-user license agreement (EULA) are replacement targets.

As illustrated in FIG. 4, first, the acquisition unit 101 acquires an application package from the server device via a network or acquires an application package from the external storage device connected to the image forming device 1, in response to the installation instruction of the user via the touch panel 18 or the input device 19 (ACT 101).

Next, the load processing unit 102 loads the acquired application package (ACT 102).

Here, the application package will be described. As illustrated in FIG. 5, the application package includes an encrypted application, attribute information, and at least one type of replacement display information. The attribute information includes an identifier uniquely indicating an application and a default application name.

As illustrated in FIG. 6, the replacement display information is associated with a destination, character string information, and image information which are targets in which the display information is to be replaced. The character string information is associated with a display language and a replacement character string. The display language indicates a type of language that can be switched and displayed by the touch panel 18 of the image forming device 1. In at least one embodiment, it is assumed that the image forming device 1 can switch between English and Japanese and display the display language. Each of the replacement character strings included in the replacement display information is a character string included in the application and is associated with a character string ID uniquely indicating a target character string which is a replacement target. The replacement character string may be associated with the replacement target, and may be associated with a character string which is a replacement target.

In at least one embodiment, the application name and a vendor name included in the EULA are referred to as target character strings. In FIG. 6, as a character string in which the display language is English, “AppNameEN”, which is a character string ID indicating an English application name, and “App H”, which is a replacement character string, are associated with each other, and “VendorVendorNameEN”, which is a character string ID indicating an English vendor name, and “Vendor B”, which is a replacement character string, are associated with each other. In addition, in FIG. 6, as a character string in which the display language is Japanese, “AppNameJP”, which is a character string ID indicating a Japanese application name, and “ [symbol] ”, which is a replacement character string, are associated with each other, and “VendorNameJP”, which is a character string ID indicating a Japanese vendor name, and “EB”, which is a replacement character string, are associated with each other.

The image information indicates a file path of a replacement image for replacing an image which is a replacement target. FIG. 6 shows a file path of an image file “icon_H2.png” which is an application icon.

As described above, in the application package, the replacement display information is separated from the encrypted application and the attribute information. Accordingly, the display information of the application can be easily changed by a person other than the developer of the application, and the application can be prevented from being modified by a person other than the developer of the application. In addition, in an old-type image forming device that does not have a function of replacing display information, since an application is installed without recognizing replacement display information, an application package for each of the image forming device 1 and the old-type image forming device is not necessary to be individually prepared.

Referring back to the description of FIG. 4. After the application package is loaded, the decoding processing unit 103 decodes the encrypted application (ACT 103). As illustrated in FIG. 7, the decoded application includes an application program, character string data, an icon file, and the like.

The application program is an executable file including an instruction to cause the processor 11 to execute processing of the application. The character string data is prepared for each display language, is displayed on the touch panel 18 when the application program is executed for each display language, and includes a character string group including the EULA and an application name. The character string ID is associated with a target character string in the character string data. The icon file is an image file for drawing a default application icon indicating an application.

After the application is decoded, the replacement processing unit 104 refers to destination information set in the own device, that is, the destination information stored in the setting storage device 16, and selects, from among one or more types of the replacement display information included in the application package, replacement display information associated with a destination indicated by the destination information (ACT 104).

Next, the replacement processing unit 104 selects an unselected display language included in the selected replacement display information (ACT 105), selects an unselected replacement character string associated with the selected display language (ACT 106), and replaces, with the selected replacement character string, a target character string associated with the selected replacement character string (ACT 107).

Next, the replacement processing unit 104 determines whether an unselected replacement character string is present among the replacement character strings associated with the selected display language in the selected replacement display information (ACT 108).

When the unselected replacement character string is not present (ACT 108, NO), it is determined whether an unselected display language is present in the selected replacement display information (ACT 109).

When the unselected display language is not present (ACT 109, NO), the replacement processing unit 104 replaces the icon file included in the decoded application with the icon file indicated in the file path included in the image information of the selected replacement display information (ACT 110), installs the application (ACT 111), and ends the processing of the installation processing device 100.

On the other hand, when the unselected display language is present (ACT 109, YES), the replacement processing unit 104 selects the unselected display language included in the selected replacement display information again (ACT 105).

When the unselected replacement character string is present in ACT 108 (ACT 108, YES), the replacement processing unit 104 selects the unselected replacement character string associated with the selected display language again (ACT 106).

According to the operation of the installation processing device 100, an application icon 181H1 and an application name 182H1 of an additional application AA included in the application selection screen as illustrated in FIG. 8 are replaced with an application icon 181H2 and an application name 182H2 as illustrated in FIG. 9. In addition, a vendor name 183A included in a EULA included in a EULA display window as illustrated in FIG. 10 is replaced with a vendor name 183B as illustrated in FIG. 11.

As described above, according to the installation processing device 100, the display information of the application can be replaced according to the destination of the image forming device 1. In addition, since the replacement display information includes only the replacement target, an increase in a data size of the application package related to the display information on each destination can be prevented.

In at least one embodiment described above, character string information of a plurality of display languages is included in the replacement display information, and the character string information of at least one display language may be included. The replacement display information includes the character string information and the image information, and the replacement display information may include any one of the character string information and the image information.

An example in which the additional application AA is installed is described, and before shipment of the image forming device 1, a standard application SA (see FIGS. 8 and 9) may be installed by the installation processing device 100 in a manufacturing factory or a sales company.

The embodiment is described above. However, the embodiment is presented as an example and is not intended to limit the scope of exemplary embodiments. These novel embodiments can be implemented in various other forms, and various omissions, substitutions, and modifications may be made without departing from the spirit of the exemplary embodiments. These embodiments and modifications are included in the scope and the gist of the exemplary embodiments and included in the exemplary embodiments described in claims and the scope of equivalents of the exemplary embodiment.

What is claimed is:

1. An installation processor configured to install an application in a device in which a destination indicating a country or a region is set, wherein
an application package of the application includes the application and replacement display information, the replacement display information including second display information associated with first display information included in the application and in which the destination is set,
the installation processor comprising:
a replacement processor configured to replace (i) the first display information corresponding to the second display information by (ii) the second display information included in the replacement display information in which a same destination as the destination set in the device is set.

2. The installation processor according to claim 1, wherein
each of the first display information and the second display information includes at least one of a character string or an image.

3. The installation processor according to claim 1, wherein
the application included in the application package is encrypted, and
the installation processor further comprising:
a decoding processor configured to decode the application prior to the replacement of the first display information by the second display information.

4. The installation processor according to claim 1, wherein
the replacement display information includes display information prepared for each display language of the device.

5. An image forming device comprising:
the installation processor according to claim 1.

6. An installation processing method for installing an application in a device in which a destination indicating a country or a region is set, wherein
an application package of the application includes the application and replacement display information, the replacement display information including second display information associated with first display information included in the application and in which the destination is set,
the installation processing method comprising: (i) replacing the first display information corresponding to the second display information by the (ii) second display information included in the replacement display information in which the same destination as the destination set in the device is set.

7. The installation processor according to claim 1, wherein the replacement display information is associated with a destination, character string information, and image information which are targets in which the first display information is to be replaced.

8. The image forming device according to claim 5, wherein the image forming device is configured to set a sheet size according to the set region or country.

9. The image forming device according to claim 5, wherein the image forming device is configured to set a toner according to the set region or country.

10. The installation processor according to claim 2, wherein the image is an icon for the application.

11. The method according to claim 6, wherein each of the first display information and the second display information includes at least one of a character string or an image.

12. The method according to claim 6, further comprising decoding the application prior to the replacement of the first display information by the second display information.

13. The method according to claim 6, wherein the replacement display information includes display information prepared for each display language of the device.
